(19) United States
(12) Patent Application Publication
(10) Pub. No.: US 2021/0390862 A1
(43) Pub. Date: Dec. 16, 2021

(54) VEHICLE DISPATCH SERVICE PROVIDING SYSTEM, SERVER FOR VEHICLE DISPATCH SERVICE, AND VEHICLE DISPATCH SERVICE PROVIDING METHOD

(71) Applicant: Toyota Jidosha Kabushiki Kaisha, Toyota-shi Aichi-ken (JP)

(72) Inventor: Toshiki Horita, Tokyo-to (JP)

(73) Assignee: Toyota Jidosha Kabushiki Kaisha, Toyota-shi Aichi-ken (JP)

(21) Appl. No.: 17/323,232

(22) Filed: May 18, 2021

(30) Foreign Application Priority Data
Jun. 11, 2020 (JP) 2020-101809

(51) Int. Cl. G08G 1/00; G06Q 10/02; G06Q 30/02; G06Q 30/08; G06Q 50/30

(52) U.S. Cl. CPC G08G 1/202; G06Q 10/02; G06Q 50/30; G06Q 30/08; G06Q 30/0284

(57) ABSTRACT

The system acquires a dispatch request including at least a boarding location, a destination, and a payment limit price from a user. When a plurality of dispatch requests matching with a dispatch condition are acquired, the system sets, as the provisional highest dispatch request, the dispatch request having the highest satisfaction in a bid evaluation item among the plurality of dispatch requests. However, when a new dispatch request that matches the dispatch condition and has a higher satisfaction in the bid evaluation item than the provisional highest dispatch request is acquired by the time the vehicle dispatch is completed, the system updates the provisional highest dispatch request. The system directs the vehicle to the boarding location designated by the provisional highest dispatch request, and when the provisional highest dispatch request is updated, the dispatch destination is changed to the boarding location designated by the updated provisional highest dispatch request.

### CROSS-REFERENCE TO RELATED APPLICATION

The present application claims priority under 35 U.S.C. §119 to Japanese Patent Application No. 2020-101809, filed Jun. 11, 2020, the contents of which are incorporated herein by reference in their entirety.

### BACKGROUND

### Field

The present disclosure relates to a technique for matching a dispatch condition with a dispatch request received from a user desiring vehicle dispatch service and dispatching a vehicle to the user who has presented the dispatch request that matches the dispatch condition,

### Background Art

Vehicle dispatch service is known which determines a combination of a user desiring the vehicle dispatch service and a vehicle by matching a dispatch condition of the vehicle with a dispatch request received from the user. For example, JP 2002-366799 A discloses a system in which each passenger and each taxi company bid mutually to find a taxi company or a passenger that meets their needs In this system, passengers and taxi companies register their desired conditions in an auction server respectively. In a company advantageous market, passengers bid to individual companies, and each company selects one passenger from among the passengers who bid to the company. In a passenger advantageous market, companies bid to individual passengers, and each passenger selects one company from among the companies who bid to the passenger.

In the above system, even if another user wants to use a taxi successfully bid by one user and presents a more advantageous condition, it is not possible to dispatch the taxi to another user as long as a bid is once established. However, there certainly exists a user who does not mind to pay a higher fee than other people if it is possible to use a taxi with a better condition, for example, a taxi that arrives earlier. The amount of money that the user is willing to pay for the taxi represents the value that the user can obtain through the use of the taxi. If the taxi cannot be dispatched to the user although the user finds higher value on the taxi, opportunity loss may occur for both the user and the taxi company.

### SUMMARY

The present disclosure has been made in view of the problems as described above. An object of the present disclosure is to optimize a combination of a user and a vehicle in the vehicle dispatch service in which the combination of the user and the vehicle is determined by matching a dispatch condition of the vehicle with a dispatch request received from the user.

In order to solve the above problems, the present disclosure provides a vehicle dispatch service providing system, a server for vehicle dispatch service, and a vehicle dispatch service providing method described below.

First, the vehicle dispatching service providing system according to the present disclosure will be described. The vehicle dispatch service providing system according to the present disclosure is a system for matching a dispatch condition of a vehicle with a dispatch request received from a user desiring vehicle dispatch service and dispatching the vehicle to the user who has presented the dispatch request that matches the dispatch condition. The present vehicle dispatch service providing system includes a dispatch request acquiring unit, a bidding unit, and a dispatching unit. These units are realized by cooperation of multiple computers which are physical components of the present vehicle dispatch service providing system. The vehicle dispatch service providing system may be a client server type system or a peer-to-peer type system.

The dispatch request acquiring unit is configured to acquire the dispatch request including at least a boarding location, a destination, and a payment limit price from the user who requests for vehicle dispatch. The bidding unit is configured to set, as a provisional highest dispatch request, the dispatch request having the highest satisfaction in a predetermined bid evaluation item among one or more dispatch requests that match the dispatch condition. The bid evaluation item may be an upper limit of a price per travel distance including travel to the boarding location. The bidding unit is configured to update the provisional highest dispatch request when a new dispatch request that matches the dispatch condition and has a higher satisfaction in the bid evaluation item than the provisional highest dispatch request is acquired by the time the vehicle dispatch is completed. The dispatching unit is configured to direct the vehicle to the boarding location designated by the provisional highest dispatch request, and, when the provisional highest dispatch request is updated while the vehicle is traveling to the boarding location designated by the provisional highest dispatch request, change a dispatch destination to the boarding location designated by the provisional highest dispatch request that is updated.

According to the vehicle dispatch service providing system in accordance with the present disclosure, the user can continue to bid until the vehicle dispatch is completed, so that the user can consider whether or not to conduct the bidding by comparing the estimated value obtained by the use of the vehicle with the provisional highest dispatch request. Then, when the user determines that it is worth utilizing the vehicle to be dispatched, the user can use the vehicle by presenting a dispatch request with a higher satisfaction in the bid evaluation item than the provisional highest dispatch request. On the other hand, a vehicle dispatcher providing the vehicle to the vehicle dispatch service, until the vehicle dispatch is completed, can wait for an offer from the user who finds higher value, that is, the user who pays a higher user fee. Therefore, according to the vehicle dispatch service providing system according to the present disclosure, it is possible to realize a combination of a user and a dispatch vehicle that can enhance both the benefit of the user and the benefit of the vehicle dispatcher.

The vehicle dispatching service providing system according to the present disclosure may further comprise a payment price determining unit that determines a payment price by second price auction method. In the second price auction method, it is the best strategy for users to honestly declare the value they find in the bid target. Each user can declare a payment limit price without worrying about the existence of other users or declared price thereof. As an example of the calculation of the payment price, the payment price determining unit may determine, as the payment price, a price obtained by multiplying the payment limit price of a competitor who has presented the dispatch request having the next highest satisfaction in the bid evaluation item after a successful bidder by a ratio of a total travel distance necessary for performing the vehicle dispatch service to the successful bidder to a total travel distance necessary for performing the vehicle dispatch service to the competitor.

In the vehicle dispatch service providing system according to the present disclosure, the dispatch condition may include at least a reservation price. Since no transaction is made at a price lower than the reservation price, which is one of the dispatch condition, the vehicle dispatcher can safely participate in the vehicle dispatch service. Although the reservation price may be arbitrarily set by the vehicle dispatcher, it may be a minimum price per travel distance including travel to the boarding location.

The vehicle dispatch service providing system according to the present disclosure may further include a dispatch condition acquiring unit and a reverse bidding unit. The dispatch condition acquiring unit is configured to acquire the dispatch condition from the vehicle dispatcher. The dispatch condition includes, for example, a reservation price, a current location of the vehicle, a dispatchable area, and the number of passengers allowed. The reverse bidding unit is configured to set, as a provisional highest dispatch condition, the dispatch condition having the highest satisfaction in a predetermined reverse bid evaluation item among one or more dispatch conditions that match the provisional highest dispatch request, The reverse bid evaluation item may be, for example, the time required for the vehicle to arrive at the dispatch destination, i.e., the waiting time for the user. In addition, the reverse bidding unit is configured to update the provisional highest dispatch condition when a new dispatch condition that matches the provisional highest dispatch request and has a higher satisfaction in the reverse bid evaluation item than the provisional highest dispatch condition is acquired by the time the vehicle dispatch is completed. If the vehicle dispatch service providing system comprises the dispatch condition acquiring unit and the reverse bidding unit, the dispatching unit is configured to dispatch the vehicle that presents the provisional highest dispatch condition for the provisional highest dispatch request, and, when the provisional highest dispatch condition is updated, change the vehicle to be dispatched for the provisional highest dispatch request to the vehicle that presents the provisional highest dispatch condition that is updated.

As described above, the reverse bidding from the vehicle dispatcher is also performed, so that the user can use the vehicle that presents the delivery condition that is more advantageous to the user. Further, since the reverse bidding is continued until the vehicle dispatch to the user is completed, when another vehicle that presents a dispatch condition that has a higher satisfaction in the predetermined reverse bid evaluation item than the provisional highest dispatch condition appears in the market, the vehicle is dispatched to the user. Thus, further optimization of the combination of the user and the dispatch vehicle is realized. In particular, if the reverse bid evaluation item is a time required for the vehicle to arrive at the dispatch destination, the waiting time from when the user presents the dispatch request until the vehicle is dispatched can be minimized. For the vehicle dispatcher, the vehicle availability can be increased because the vehicle can be dispatched to the user to whom the vehicle can be dispatched in a shorter time.

Incidentally, the vehicle dispatch service providing system according to the present disclosure can also be applied to the vehicle dispatch service of an autonomous driving vehicle, and also can be applied to the vehicle dispatch service of a manually operated vehicle such as a taxi. In the case of the autonomous driving vehicle, the autonomous driving vehicle may be operated according to instructions from the dispatching unit.

Next, the server for vehicle dispatch service according to the present disclosure will be described. The server for vehicle dispatch service according to the present disclosure is connected to one or more user terminals via a communication network. The server according to the present disclosure comprises at least one processor and at least one memory including at least one program coupled with the at least one processor. The at least one program causes the at least one processor, which is a physical component of the server according to the present disclosure, to execute a dispatch request receiving process, a bidding process, a dispatch process, a re-bidding process, and a dispatch destination changing process.

The dispatch request receiving process is a process of receiving a dispatch request including at least a boarding location, a destination, and a payment limit price from the one or more user terminals. The bidding processing is a process of setting, as a provisional highest dispatch request, the dispatch request having the highest satisfaction in a predetermined bid evaluation item among one or more dispatch requests that match a dispatch condition of a vehicle. The dispatch condition may include at least a reservation price. The reservation price may be a minimum price per travel distance including travel to the boarding location. The bid evaluation item may be, for example, an upper limit of a price per travel distance including travel to the boarding location. The dispatching process is a process of directing the vehicle to the boarding location designated by the provisional highest dispatch request. The re-bidding process is a process of updating the provisional highest dispatch request when a new dispatch request that matches the dispatch condition and has a higher satisfaction in the bid evaluation item than the provisional highest dispatch request is received by the time the vehicle dispatch is completed. Then, the dispatch destination changing process is a process of changing a dispatch destination, when the provisional highest dispatch request is updated, to the boarding location designated by the provisional highest dispatch request that is updated.

In the server for vehicle dispatch service according to the present disclosure, the at least one program may be configured to cause the at least one processor to further perform a payment price determining process of determining a payment price by second price auction method. In the payment price determining process, a price obtained by multiplying a payment limit price included in the dispatch request having the second highest satisfaction in the bid evaluation item by a ratio of a total travel distance calculated from the dispatch request having the highest satisfaction to a total travel distance calculated from the dispatch request having the second highest satisfaction may be determined as the payment price.

The server for vehicle dispatch service according to the present disclosure may be connected to one or more dispatcher terminals via the communication network. In that case, the at least one program may further cause the at least one processor to execute a dispatch condition receiving process, a re-reverse bidding process, a dispatch vehicle selecting process, and a dispatch vehicle changing process.

The dispatch condition receiving process is a process of receiving the dispatch condition from the one or more dispatcher terminals, the dispatch condition including at least the time required for the vehicle to arrive at the dispatch destination. The reverse bidding process is a process of setting, as a provisional highest dispatch condition, the dispatch condition having the highest satisfaction in a predetermined reverse bid evaluation item among one or more dispatch conditions that match the provisional highest dispatch request. The dispatching vehicle selecting process is a process of dispatching the vehicle that presents the provisional highest dispatch condition for the provisional highest dispatch request. The re-reverse bidding process is a process of updating the provisional highest dispatch condition when a new dispatch condition that matches the provisional highest dispatch request and has a higher satisfaction in the reverse bid evaluation item than the provisional highest dispatch condition is received by the time the vehicle dispatch is completed. The dispatch vehicle changing process is a process of changing the vehicle to be dispatched for the provisional highest dispatch request, when the provisional highest dispatch condition is updated, to the vehicle that presents the provisional highest dispatch condition that is updated.

Next, the vehicle dispatch service providing method according to the present disclosure will be described. The vehicle dispatch service providing method according to the present disclosure is a method for matching a dispatch condition of a vehicle with a dispatch request received from a user desiring vehicle dispatch service and dispatching the vehicle to the user who has presented the dispatch request that matches the dispatch condition. The dispatch condition may include at least a reservation price. The reservation price may be a minimum price per travel distance including travel to a boarding location.

The vehicle dispatch service providing method according to the present disclosure includes the following steps. The first step is a step of receiving a dispatch request including at least a boarding location, a destination, and a payment limit price from one or more users. The second step is a step of setting, as a provisional highest dispatch request, the dispatch request having the highest satisfaction in a predetermined bid evaluation item among one or more dispatch requests that match the dispatch condition, and granting dispatch priority of the vehicle to the user who has presented the provisional highest dispatch request. The third step is a step of directing the vehicle to the boarding location designated by user who has the dispatch priority. The fourth step is a step of updating the provisional highest dispatch request when a new dispatch request that matches the dispatch condition and has a higher satisfaction in the bid evaluation item than the provisional highest dispatch request is received by the time the vehicle dispatch is completed, and transferring the dispatch priority to the user who has presented the provisional highest dispatch request that is updated. Then, the fifth step is a step of changing a dispatch destination, when the dispatch priority is transferred to another user, to the boarding location designated by another user who has acquired the dispatch priority.

The vehicle dispatch service providing method according to the present disclosure may further include, as the sixth step, a step of determining a payment price by second price auction method. The payment price may be calculated by multiplying a payment limit price of a competitor who has presented the dispatch request having the next highest satisfaction in the bid evaluation item after a successful bidder by a ratio of a total travel distance necessary for performing the vehicle dispatch service to the successful bidder to a total travel distance necessary for performing the vehicle dispatch service to the competitor.

The vehicle dispatch service providing method according to the present disclosure may further include the following steps. The seventh step is a step of receiving the dispatch condition from one or more vehicle dispatchers that provide the vehicle to the vehicle dispatch service. The eighth step is a step of setting, as a provisional highest dispatch condition, the dispatch condition having the highest satisfaction in a predetermined reverse bid evaluation item among one or more dispatch conditions that match the provisional highest dispatch request, and granting to the user who has presented the provisional highest dispatch request the dispatch priority of the vehicle that presents the provisional highest dispatch condition. The ninth step is a step of updating the provisional highest dispatch condition when a new dispatch condition that matches the provisional highest dispatch request and has a higher satisfaction in the reverse bid evaluation item than the provisional highest dispatch condition is received by the time the vehicle dispatch is completed, and changing the dispatch priority granted to the user who has presented the provisional highest dispatch request to the dispatch priority of the vehicle that presents the provisional highest dispatch condition that is updated.

The vehicle dispatch service providing method according to the present disclosure is, for example, a method achieved by cooperation of a plurality of computers constituting a client-server type system or a peer-to-peer type system.

According to the above-described vehicle dispatch service providing system, the server for vehicle dispatch service, and the vehicle dispatch service providing method, it is possible to realize a combination of a user and a dispatch vehicle that can enhance both the benefit of the user and the benefit of the vehicle dispatcher.

### BRIEF DESCRIPTION OF THE DRAWINGS

FIG. 1 is a diagram showing a configuration of a vehicle dispatch service providing system according to an embodiment of the present disclosure.

FIG. 2 is a diagram showing functions of an auction server constituting the vehicle dispatch service providing system.

FIG. 3 is a diagram showing an example of a dispatch request and a dispatch condition used for bi-directional bidding.

FIG. 4 is a diagram schematically showing an outline of the vehicle dispatch service performed between a plurality of users and a single vehicle.

FIG. 5 is a flowchart showing the relationship between the plurality of users, the single vehicle and an auction server in the case shown in FIG. 4.

FIG. 6 is a diagram schematically showing an outline of the vehicle dispatch service performed between a single user and a plurality of vehicles.

FIG. 7 is a flowchart showing the relationship between the single user, the plurality of vehicles and an auction server in the case shown in FIG. 6.

### DETAILED DESCRIPTION

Hereunder, embodiments of the present disclosure will be described with reference to the drawings. Note that when the numerals of numbers, quantities, amounts, ranges and the like of respective elements are mentioned in the embodiments shown as follows, the present disclosure is not limited to the mentioned numerals unless specially explicitly described otherwise, or unless the disclosure is explicitly designated by the numerals theoretically. Furthermore, structures and steps that are described in the embodiments shown as follows are not always indispensable to the disclosure unless specially explicitly shown otherwise, or unless the disclosure is explicitly designated by the structures or the steps theoretically.

### 1. Configuration of Vehicle Dispatch Service Providing System

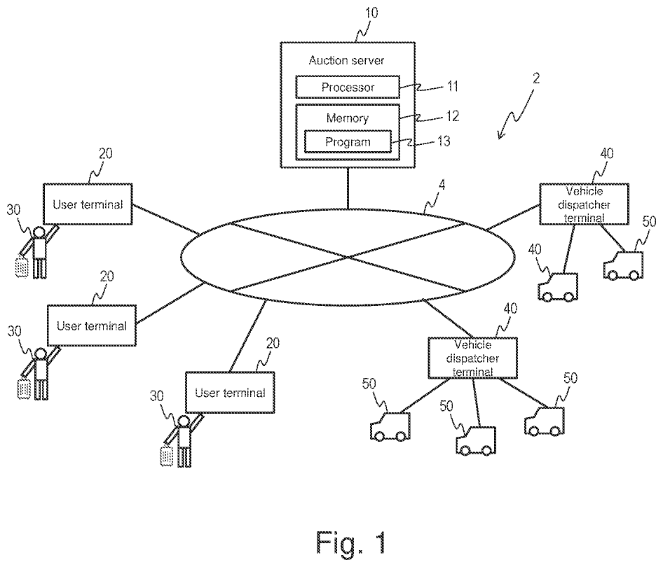

The configuration of the vehicle dispatch service providing system according to an embodiment of the present disclosure is shown in FIG. 1. The vehicle dispatch service providing system 2 according to the present embodiment is a client-server type system including an auction server 10 and a user terminal 20 and a dispatcher terminal 40 connected to the auction server 10 via a communication network 4. The auction server 10 includes, as its physical components, at least one processor 11 and at least one memory 12 that stores at least one program 13 for providing vehicle dispatch service. The auction server 10 communicates with one or more user terminals 20 and one or more dispatcher terminals 40 via the communication network 4. The communication network 4 includes radio communications such as 4G and 5G.

The user terminal 20 is a portable terminal connectable to the auction server 10 via the communication network 4 such as a smartphone, tablet, or the like. The user terminal 20 is provided with a self-location estimation function using GPS or wireless base stations. The user terminal 20 is used by a user 30 who wishes to utilize the vehicle dispatch service.

The dispatcher terminal 40 is a computer that can be connected to the auction server 10 via the communication network 4. The dispatcher terminal 40 is used by a vehicle dispatcher that provides vehicles 50 to the vehicle dispatch service. The vehicle dispatcher of the present embodiment is a different company from the company that manages the auction server 10, that is, the company that operates the vehicle dispatch service. The dispatcher terminal 40 is arranged, for example, in a management center where the operation of the vehicle 50 is managed. One dispatcher terminal 40 may manage a plurality of vehicles 50 as shown in FIG. 1, and also one dispatcher terminal 40 may manage only one vehicle 50.

The vehicle 50 used in the vehicle dispatch service in the present embodiment is an autonomous driving vehicle capable of autonomous traveling depending on information acquired by vehicle-mounted sensors and information obtained from outside. The vehicle 50 communicates with the dispatcher terminal 40, and operates upon receiving an instruction from the dispatcher terminal 40. The location information of the vehicle 50 is transmitted from the vehicle 50 to the dispatcher terminal 40. The information necessary for autonomous traveling such as a dispatch location and a destination is transmitted from the dispatcher terminal 40 to the vehicle 50.

### 2. Function of Auction Server

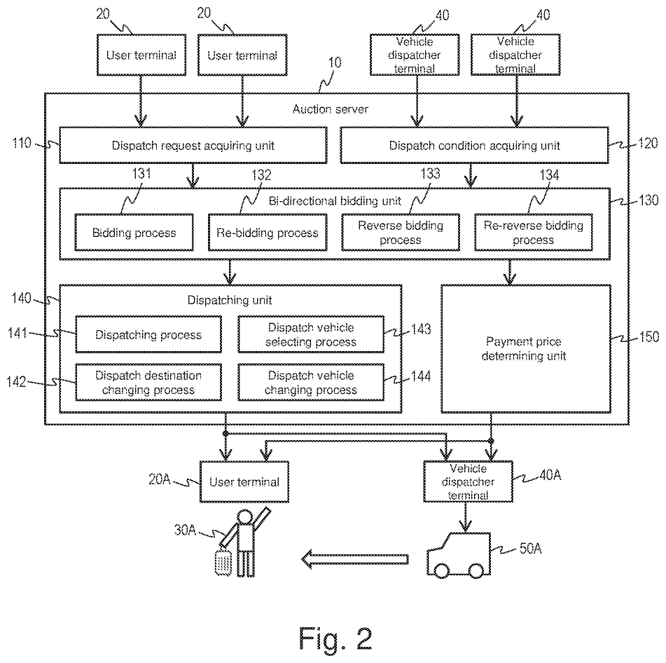

FIG. 2 is a diagram showing the function of the auction server 10 constituting the vehicle dispatch service providing system 2. The program 13 stored in the memory 12 is executed by the processor 11 (see FIG. 1), so that the processor 11 functions as at least a dispatch request acquiring unit 110, a dispatch condition acquiring unit 120, a bi-directional bidding unit 130, a dispatching unit 140, and a payment price determining unit 150. The functions of the auction server 10 will be described below.

The dispatch request acquiring unit 110 includes an input interface that receives information transmitted from the user terminal 20 to the auction server 10. The information transmitted from the user terminal 20 to the auction server 10 is a dispatch request. The dispatch request acquiring unit 110 receives the dispatch requests from the plurality of user terminals 20. A web page displayed on a screen of the user terminal 20 when the user terminal 20 connects to the auction server 10 is provided with an input form of request items for the dispatch request. The user only needs to fill in the input form and send the data. Since the request items that the user can input to the user terminal 20 are determined by the input form, the request items of the dispatch request received by the dispatch request acquiring unit 110 from each user terminal 20 are unified. The dispatch request acquired by the dispatch request acquiring unit 110 is input to the bi-directional bidding unit 130.

The dispatch condition acquiring unit 120 includes an input interface for receiving information transmitted from the dispatcher terminal 40 to the auction server 10. The information transmitted from the dispatcher terminal 40 to the auction server 10 is a dispatch condition. The dispatch condition acquiring unit 120 receives the dispatch conditions from the plurality of dispatcher terminals 40. Condition items of the dispatch conditions received by the dispatch condition acquiring unit 120 from each dispatcher terminal 40 are unified. The dispatch condition acquired by the dispatch condition acquiring unit 120 is input to the bi-directional bidding unit 130.

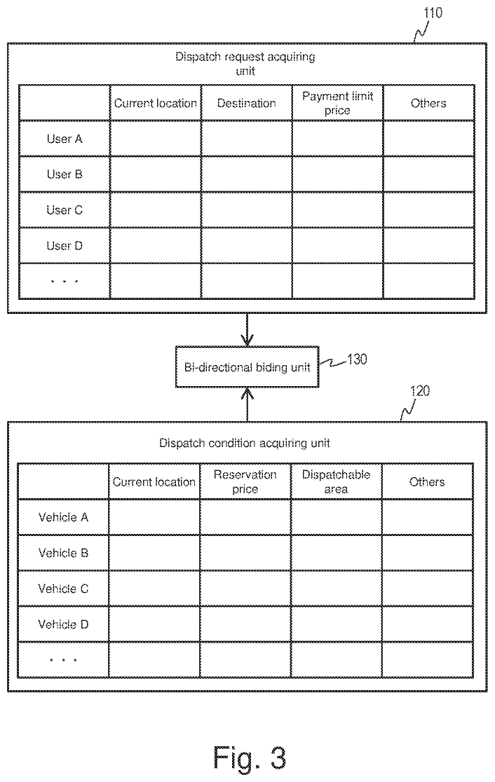

Here, FIG. 3 is a diagram showing an example of a dispatch request and a dispatch condition used for bi-directional bidding in the bi-directional bidding unit 130. The dispatch request is a request regarding the content of the dispatch from the user to the vehicle dispatcher. The request items for the dispatch request include, for example, a current location, a destination, and a payment limit price. The current location is the user's current location, expressed in latitude and longitude. The current location estimated by the user terminal's self-location estimation function is automatically set as a boarding location. However, if the user wishes to dispatch the vehicle to a different location from the current location, a different location from the current location can also be designated as the boarding location. The destination is where the user wants to go. The name of the destination may be input, or the destination may be selected from the map. The payment limit price is an upper limit of the utilization price of the vehicle dispatch service, which the user considers may pay. In addition to these, the dispatch request may include, for example, an upper limit of the arrival time, the number of passengers on board, an evaluation of the vehicle dispatcher, and the like as arbitrary request items.

The dispatch condition is a condition of the vehicle dispatch which the vehicle dispatcher presents to the user. The condition items for the dispatch condition include, for example, a current location, a reservation price, and a dispatchable area. The current location is where the vehicle is. The current location of the vehicle is obtained by information from the GPS terminal mounted on the vehicle. The reservation price is a minimum price at which the vehicle dispatcher is willing to provide the vehicle dispatch service. The reservation price may be a minimum price per travel distance including travel to the boarding location, or may be a minimum price for each section that varies stepwise with distance, or may be a fixed minimum price that does not depend on distance. The dispatchable area represents an area where the vehicle dispatcher can dispatch vehicles. In addition to these, the dispatch condition, for example, may include the number of passengers, an evaluation of users and the like as arbitrary condition items.

Returning to FIG. 2 again, the function of the auction server 10 will be described. The bi-directional bidding unit 130 matches the dispatch requests acquired by the dispatch request acquiring unit 110 with the dispatch conditions acquired by the dispatch condition acquiring unit 120. For this matching, the bi-directional bidding unit 130 executes a bidding process 131, a re-bidding process 132, a reverse bidding process 133, and a re-reverse bidding process 134. The bidding process 131 and the re-bidding process 132 are functions as a bidding unit of the bi-directional bidding unit 130. The reverse bidding process 133 and the re-reverse bidding process 134 are functions as a reverse bidding unit of the bi-directional bidding unit 130. In the present embodiment, the act of selecting a user that gives the most advantageous dispatch request for the vehicle among a plurality of users is referred to as the bidding, and conversely, the act of selecting a vehicle that gives the most advantageous dispatch condition for the user among a plurality of vehicles is referred to as the reverse bidding.

The bidding process 131 is a process of selecting, from among the dispatch requests presented by a plurality of users, the most advantageous dispatch request for the vehicle dispatcher who presents the most advantageous dispatch condition in common among the plurality of users. Whether the dispatch condition is advantageous for the user is determined by the satisfaction in a predetermined reverse bid evaluation items. The higher the satisfaction in the inverse bid evaluation items, the more advantageous the dispatch condition for the user. The main item of the reverse bid evaluation items in the present embodiment is the time required for the vehicle to arrive at the designated boarding location, that is, the waiting time for the user until the vehicle is dispatched. The required time is calculated based on the distance from the current location of the vehicle to the boarding location and traffic conditions. The traffic conditions include, for example, legal speed on the driving route, the number of signals, a congestion condition, etc. The shorter the time required to arrive at the boarding location, the more advantageous for the user, and the higher the satisfaction in the reverse bid evaluation items. Hereafter, the dispatch condition having the highest satisfaction in the reverse bid evaluation items is referred to as the highest dispatch condition. However, as will be described later, the highest dispatch condition varies depending on the situation of the reverse bidding, so the highest dispatch condition is provisional until the result of the reverse bidding is decided. The highest dispatch condition until the result of the reverse bidding is decided is referred to as the provisional highest dispatch condition.

Whether the dispatch request is advantageous for the vehicle dispatcher is determined by the satisfaction in a predetermined bid evaluation items. The higher the satisfaction in the bid evaluation items, the more advantageous the dispatch request for the vehicle dispatcher. The main item of the bid evaluation items in the present embodiment is an upper limit of the price per travel distance including travel to the boarding location. The sum of the distance from the current location of the vehicle to the boarding location and the distance from the boarding location to the destination is the total travel distance, and the upper limit of the price per travel distance can be calculated by dividing the payment limit price presented by the user by the total travel distance. The greater the upper limit of the price per travel distance, the higher the satisfaction in the bid evaluation items. It can be said that the dispatch request having the highest satisfaction in the bid evaluation items is the most advantageous dispatch request for the vehicle dispatcher. Hereinafter, the dispatch request by which the upper limit of the price per travel distance is maximized is referred to as the highest dispatch request. However, as described later, since the highest dispatch request varies depending on the situation of the bidding, the highest dispatch request is provisional until the result of the bidding is decided. The highest dispatch request until the result of the bidding is decided is referred to as the provisional highest dispatch request.

The bi-directional bidding unit 130 grants priority of dispatch of the vehicle to the user who has presented the dispatch request having the highest satisfaction in the bid evaluation items among a plurality of dispatch requests, when the plurality of dispatch requests meet the provisional highest dispatch condition. Hereinafter, this priority is referred to as the dispatch priority. A notification indicating that the dispatch priority has been granted is transmitted from the auction server 10 to the user terminal 20. The user can confirm, for example, that the user currently has the dispatch priority on the web page displayed on the user terminal 20. In addition, in the bidding process 131, the dispatch request having the highest satisfaction in the bidding evaluation items is set as the provisional highest dispatch request. In other words, the user who has presented the provisional highest dispatch request would be the user who has dispatch priority. If there is only one dispatch request that meets the provisional highest dispatch condition, the request is set as the provisional highest dispatch request.

The re-bidding process 132 is a process of updating the provisional highest dispatch request when it receives a new dispatch request that meets the provisional highest dispatch condition and has a higher satisfaction in the bid evaluation items than the provisional highest dispatch request. The bi-directional bidding unit 130 transfers the dispatch priority to the user who has presented the updated provisional highest dispatch request at the same time as the update of the provisional highest dispatch request. For the original user who had the dispatch priority, a notification indicating that the dispatch priority has been extinguished is transmitted from the auction server 10 to the user terminal 20. The re-bidding process 132 can be performed until the vehicle dispatch is completed. The bidding terminates when the vehicle arrives at the user who has the dispatch priority. This means that for a user, there is an opportunity to win the dispatch priority of a vehicle by conducting the re-bidding, by the time the vehicle arrives at another user who has the dispatch priority of the vehicle. It should be noted that the completion of the vehicle dispatch may be arbitrarily defined. For example, the time when the vehicle arrives may be a time when the vehicle confirms the user with the camera, or may be a time when the vehicle enters an area within a predetermined distance from the boarding location.

The reverse bidding process 133 is a process of setting the dispatch condition with the highest satisfaction in the aforementioned reverse bid evaluation items among a plurality of dispatch conditions to the provisional highest dispatch condition when the plurality of dispatch conditions meet the provisional highest dispatch request. The re-reverse bidding process 134 is a process of updating the provisional highest request condition when a new dispatch condition that meets the provisional highest dispatch request and has a higher satisfaction in the reverse bid evaluation items than the provisional highest dispatch conditions is received. The re-reverse bidding process 134 can be performed until the vehicle dispatch is completed. The reverse bidding ends when the vehicle arrives at the user who has the dispatch priority. This means that for a vehicle dispatcher, there is an opportunity to acquire a user by changing the dispatch condition and conducting the re-reverse bidding, by the time when another vehicle dispatcher's vehicle arrives at the user.

In the bidding process 131 and the re-bidding process 132 described above, the bid evaluation items include items such as the upper limit of the price per travel distance, which is the main item, the number of passengers allowed to board the vehicle to be dispatched, the evaluation of the vehicle dispatcher, and the like. The bi-directional bidding unit 130 performs matching by setting the gain to zero or a small value for items that do not satisfy conditions among these bid evaluation items. In the reverse bidding process 133 and the re-reverse bidding process 134, the reverse bid evaluation items include the time required to arrive at the boarding location, which is the main item, as well as items such as the prospect that the next user can be obtained near the destination, the number of passengers on board, the evaluation of the user, and the like. The bi-directional bidding unit 130 performs matching by setting the gain to zero or a small value for items that do not satisfy conditions among these reverse bid evaluation items. For example, the DA algorithm that is one of the one-to-one matching algorithms may be used as the algorithm for matching by the bi-directional bidding unit 130.

The dispatching unit 140 will be described. The dispatching unit 140 dispatches the vehicle 50A to the user 30A based on the result of matching by the bi-directional bidding unit 130. The vehicle 50A is the vehicle that finally came to be dispatched, and the user 30A is the user who finally won the dispatch priority of the vehicle 50A. For dispatching the vehicle, the dispatching unit 140 executes a dispatching process 141, a dispatch destination changing process 142, a dispatch vehicle selecting process 143, and a dispatch vehicle changing process 144.

The dispatching process 141 is a process of directing the vehicle to the boarding location designated by the provisional highest dispatch request, that is, the boarding location designated by the user having the dispatch priority. The vehicle directed to the boarding location is determined by the dispatch vehicle selecting process 143. The dispatching vehicle selecting process 143 is a process of dispatching the vehicle presenting the provisional highest dispatch condition for the provisional highest dispatch request. The dispatching unit 140 instructs the dispatcher terminal 40 to dispatch the vehicle determined by the dispatch vehicle selecting process 143.

The dispatch destination changing process 142 is executed when the provisional highest dispatch request is updated and the dispatch priority is transferred to another user. The dispatch destination changing process 142 is a process of changing the dispatch destination of the vehicle to the boarding location designated by the updated provisional highest dispatch request, that is, the boarding location designated by the user to whom the dispatch priority has been transferred. When it becomes impossible to change the provisional highest dispatch request, the user 30A who can receive the dispatch of the vehicle 50A, i.e., the successful bidder, is decided. For the determined user 30A, a utilization decision notification including the ID information of the vehicle 50A is transmitted from the auction server 10 to the user terminal 20A.

When the provisional highest dispatch condition is updated, the dispatch vehicle changing process 144 is executed. The dispatch vehicle changing process 144 is a process of changing the vehicle to be dispatched for the provisional highest dispatch request to the vehicle that presents the updated provisional highest dispatch condition. When the vehicle to be dispatched is changed, the dispatching unit 140 notifies the cancellation of the dispatch to the dispatcher terminal 40 that manages the vehicle before the change. When it becomes impossible to change the provisional highest dispatch condition, the vehicle 50A to be dispatched to the user 30A, who is the successful bidder, is decided. For the determined vehicle 50A, the travel route to the destination or destination requested by the user 30A is transmitted from the dispatcher terminal 40A.

Next, the payment price determining unit 150 will be described. The payment price determining unit 150 determines the payment price for the user 30A to pay for the vehicle 50A based on the result of matching by the bi-directional bidding unit 130. The payment price determining unit 150 uses the second price auction method for determining the payment price. Here, the payment limit price of a competitor who has presented the dispatch request having the next highest satisfaction in the bid evaluation items after the user 30A is assumed to be a, the total travel distance necessary for performing the vehicle dispatch service to the user 30A is assumed to be x, and the total travel distance necessary for performing the vehicle dispatch service to the competitor is assumed to be y. The payment price determining unit 150 determines the payment price p that the user 30A pays for the vehicle 50A by the following Equation 1.

p=x*a/y Equation 1

Here, assuming that the payment limit price of the user 30A is b, the following Equation 2 holds. Therefore, it can be seen that the payment price p actually paid by the user 30A is always lower than the payment limit price b set by the user. In the second price auction method, since it is the best strategy for the user to honestly declare the value that the user finds in the bid target, each user can declare the payment limit price without worrying about the presence of other users or declared price thereof.

b/x>a/y Equation 2

When the bidder is only the user 30A, the payment price determining unit 150 determines the payment price p that the user 30A pays for the vehicle 50A by the following Equation 3. In Equation 3, c is the reservation price of the vehicle 50A set by the vehicle dispatcher providing the vehicle 50A. In other words, if there are no competitors, the user 30A can receive the vehicle dispatch service at the reservation price. For the vehicle dispatchers, setting the reservation price prevents the deficit operation of the vehicle dispatch service.

p=x*c Equation 3

The payment price determining unit 150 transmits the determined payment price p to the user terminal 20A and the dispatcher terminal 40A. In the case of a system of paying the fee first, the user 30A pays using the user terminal 20A when boarding into the vehicle 50A. In the case of a system of paying the fee later, the user 30A pays using the user terminal 20A when leaving the vehicle 50A. A transaction may be made directly between the user 30A and the vehicle dispatcher providing the vehicle 50A, or may be made via the auction server 10.

### 3. Flow of Vehicle Dispatch Service

Next, the flow of the vehicle dispatch service provided by the vehicle dispatch service providing system according to the present embodiment will be described with reference to specific examples.

### 3-1. Specific Example 1

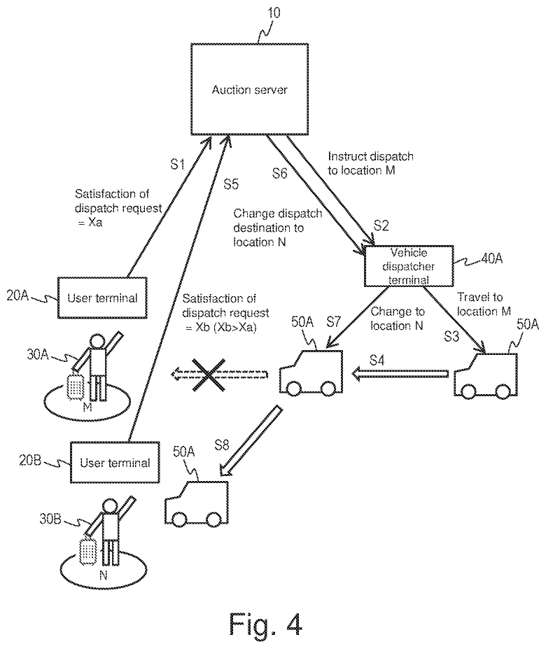

FIG. 4 is a diagram schematically showing an outline of the vehicle dispatch service performed between the plurality of users 30A and 30B and the single vehicle 50A. In the example shown in FIG. 4, the vehicle 50A is pre-participating in a competitive market for the vehicle dispatch service, followed by the user 30A participating in the competitive market. The user 30A operates the user terminal 20A to send a dispatch request to the auction server 10 (Step S1). The satisfaction in the bid evaluation items of the dispatch request sent by the user 30A is Xa. If the user participating in the competitive market is only the user 30A, the dispatch request sent by the user 30A becomes the provisional highest dispatch request. The auction server 10 grants the dispatch priority of the vehicle 50A to the user 30A who presented the provisional highest dispatch request.

The auction server 10 instructs the dispatcher terminal 40A to direct the vehicle 50A to the location M (Step S2). The location M is the boarding location designated in the dispatch request by the user 30A having the dispatch priority. The dispatcher terminal 40A instructs the vehicle 50A to travel to the location M (Step S3). The vehicle 50A starts traveling to the location M upon receiving an instruction from the dispatcher terminal 40A (Step S4).

The user 30B will participate in the competitive market for the vehicle dispatch service by the time the vehicle 50A arrives at the location M. The user 30B operates the user terminal 20B to send a dispatch request to the auction server 10 (Step S5). The satisfaction in the bid evaluation items of the dispatch request sent by the user 30B is Xb. If the satisfaction Xb is higher than the satisfaction Xa, the dispatch request sent by the user 30B becomes the new provisional highest dispatch request. The auction server 10 transfers the dispatch priority from the user 30A to the user 30B and notifies the user 30A of the extinction of the dispatch priority.

The auction server 10 changes the dispatch destination of the vehicle 50A from the location M to the location N, and instructs the dispatcher terminal 40A to direct the vehicle 50A to the location N (Step S6). The location N is the boarding location designated by the user 30B, who has acquired the dispatch priority, in the dispatch request. The dispatcher terminal 40A instructs the vehicle 50A to change the destination from the location M to the location N (step S7). The vehicle 50A stops traveling to the location M upon receiving an instruction from the dispatcher terminal 40A, and starts traveling to the location N (Step S8).

As described in the above specific example, according to the dispatch service providing system in accordance with the present embodiment, the users 30A and 30B can participate in the bidding for the vehicle 50A until the dispatch of the vehicle 50A to another user is completed. When determining that it is worth utilizing the vehicle 50A, the users 30A and 30B becomes enable to utilize the vehicle 50A by presenting a dispatch request that has a higher satisfaction than other users. On the other hand, the vehicle dispatcher providing the vehicle 50A can wait for offers from users who find higher value for the vehicle 50A until the vehicle dispatch is completed. That is, according to the vehicle dispatch service providing system according to the present embodiment, it is possible to realize a combination of a user and a vehicle that can enhance both the benefit of the user and the benefit of the vehicle dispatcher.

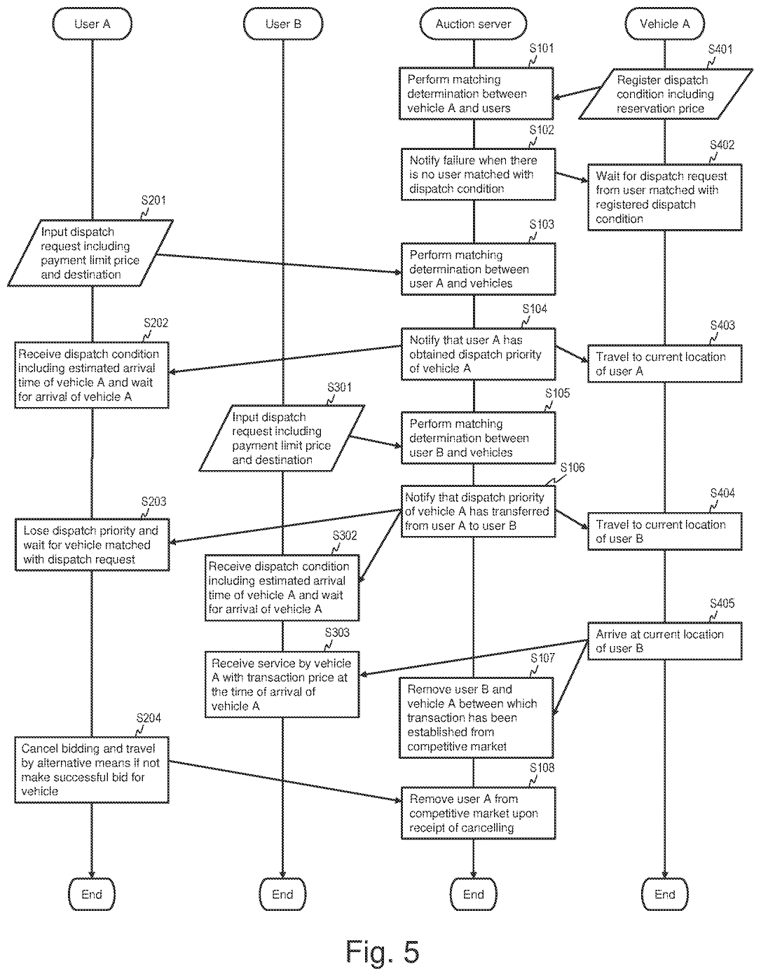

FIG. 5 is a flowchart showing the relationship between the users 30A and 30B, the vehicle 50A, and the auction server 10 in the case shown in FIG. 4. In the flowchart, the users 30A and 30B are denoted as User A and User B, and the vehicle 50A is denoted as Vehicle A.

If the vehicle 50A participates in the competitive market, the vehicle 50A registers a dispatch condition including a reservation price to the auction server 10 by using the dispatcher terminal (Step S401). The auction server 10 in which the dispatch condition is registered performs a matching determination between users and the vehicle 50A (Step S101). If no user meets the dispatch condition as a result of the matching determination, the auction server 10 notifies the vehicle 50A of the failure of the matching (Step S102). The vehicle 50A that has received the notification of the failure waits for the dispatch request from the user that meets the entered dispatch condition (Step S402).

If the user 30A participates in the competitive market, the user 30A inputs a dispatch request including a payment limit price and destination to the auction server 10 by using the user terminal (Step S201). The auction server 10 in which the dispatch request is input performs a matching determination between the user 30A and vehicles (Step S103). If a match is established between the user 30A and the vehicle 50A, the auction server 10 notifies both the user 30A and the vehicle 50A that the user 30A has obtained the dispatch priority of the vehicle 50A (Step S104). The user 30A receives the dispatch condition including an estimated arrival time of the vehicle 50A and waits for the arrival of the vehicle 50A (Step S202). The vehicle 50A travels to the current location of the user 30A upon receipt of a notification from the auction server 10 (Step S403).

If the user 30B participates in the competitive market, the user 5301 inputs a dispatch request including a payment limit price and destination to the auction server 10 by using the user terminal (Step S301). The auction server 10 in which the dispatch request is input performs a matching determination between the user 30B and vehicles (Step S105). Until the vehicle 50A arrives at the current location of the user 30A, the vehicle 50A is also subject to the matching determination with the user 30B in the competitive market. If a match is established between the user 30B and the vehicle 50A, the auction server 10 notifies the vehicle 50A that the dispatch priority has transferred from the user 30A to the user 30B. Further, the auction server 10 notifies the user 30B that the user 30B has obtained the dispatch priority of the vehicle 50A, and notifies the user 30A that the dispatch priority of the vehicle 50A has been extinguished (Step S106). The user 30B receives the dispatch condition including an estimated arrival time of the vehicle 50A and waits for the arrival of the vehicle 50A (Step S302). The vehicle 50A travels to the current location of the user 30B upon receipt of a notification from the auction server 10 (Step S404). On the other hand, the user 30A that has lost the dispatch priority will wait for matching with another vehicle having the dispatch condition that meets the entered dispatch request (Step S203).

When the vehicle 50A arrives at the current location of the user 30B, the vehicle 50A notifies the auction server 10 and the user 30B of arrival at the dispatch destination (Step S405). The auction server 10 removes the user 30A and the vehicle 50A between which the transaction was established from the competitive market (Step S107). This prevents other users from bidding for the vehicle 50A. The user 30B receives the service by the vehicle 50A at the transaction price established at the time of arrival of the vehicle 50A (Step S303). After the vehicle 50A arrives at the destination, the user 30B pays the fee and evaluates the vehicle dispatch service by the vehicle 50A.

If the user 30A fails to win the vehicle in the competitive market, the user 30A may cancel the bidding, and travel by an alternative means (Step S204). The auction server 10 then receives a notification of cancellation from the user 30A to remove the user 30A from the competitive market (Step S108).

### 3-2. Specific Example 2

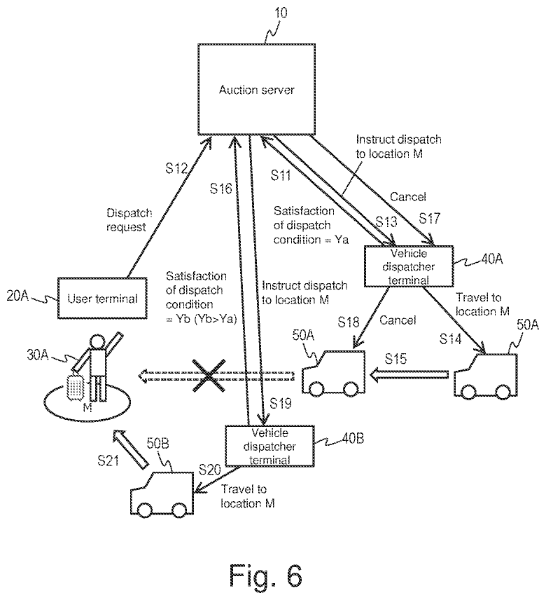

FIG. 6 is a diagram schematically showing an outline of the vehicle dispatch service performed between the single user 30A and the plurality of vehicles 50A and 50B. In the example shown in Fig.6, the vehicle 50A has participated in the competitive market in advance, the dispatch condition of the vehicle 50A is transmitted from the dispatcher terminal 40A to the auction server 10 (Step S11). The satisfaction in the reverse bid evaluation items of the dispatch condition of the vehicle 50A transmitted by the dispatcher terminal 40A is Ya. Subsequently, the user 30A participates in the competitive market for the vehicle dispatch service. The user 30A operates the user terminal 20A to send a dispatch request to the auction server 10 (Step S12). If the vehicle participating in the competitive market is the vehicle 50A only, the dispatch condition of the vehicle 50A will be the provisional highest dispatch condition. The auction server 10 grants the dispatch priority of the vehicle 50A to the user 30A.

The auction server 10 instructs the dispatcher terminal 40A to direct the vehicle 50A to the location M (Step S13). The location M is the boarding location designated in the dispatch request by the user 30A having the dispatch priority. The dispatcher terminal 40A instructs the vehicle 50A to travel to the location M (Step S14). The vehicle 50A starts traveling to the location M upon receiving an instruction from the dispatcher terminal 40A (Step S15).

The vehicle 50B will participate in the competitive market until the vehicle 50A arrives at the location M. The dispatch condition of the vehicle 50B is transmitted from the dispatcher terminal 40B to the auction server 10 (Step S16). The satisfaction in the reverse bid evaluation items of the dispatch condition of the vehicle 50B transmitted by the dispatcher terminal 40B is Yb. If the satisfaction Yb is higher than the satisfaction Ya, the dispatch condition of the vehicle 50B will be the new provisional highest dispatch condition. The auction server 10 changes the dispatch priority granted to the user 30A from the dispatch priority of the vehicle 50A to the dispatch priority of the vehicle 50B. Then, the auction server 10 notifies the cancellation of the dispatch to the dispatcher terminal 40A (Step S17). The vehicle 50A stops traveling to the location M upon receiving an instruction from the dispatcher terminal 40A (Step S18).

The auction server 10 instructs the dispatcher terminal 40B to direct the vehicle 50B to the location M where the user 30A is present (Step S19). The dispatcher terminal 40B instructs the vehicle 50B to travel to the location M (Step S20). The vehicle 50B starts traveling to the location M upon receiving an instruction from the dispatcher terminal 40B (Step S21).

If the reverse bidding is performed by the vehicles 50A and 50B as in the above specific example, the user 30A will be able to utilize the vehicle presenting the dispatch condition that is more advantageous to the user 30A. Further, since the reverse bidding continues until the vehicle dispatch to the user 30A is completed, when another vehicle that presents a dispatch condition having a higher satisfaction appears in the competitive market, the vehicle will be dispatched to the user 30A. Thus, further optimization of the combination of the user and the dispatch vehicle is realized. In particular, if the reverse bid evaluation items include the time required for the vehicle to arrive at the destination, the waiting time for the user can be minimized.

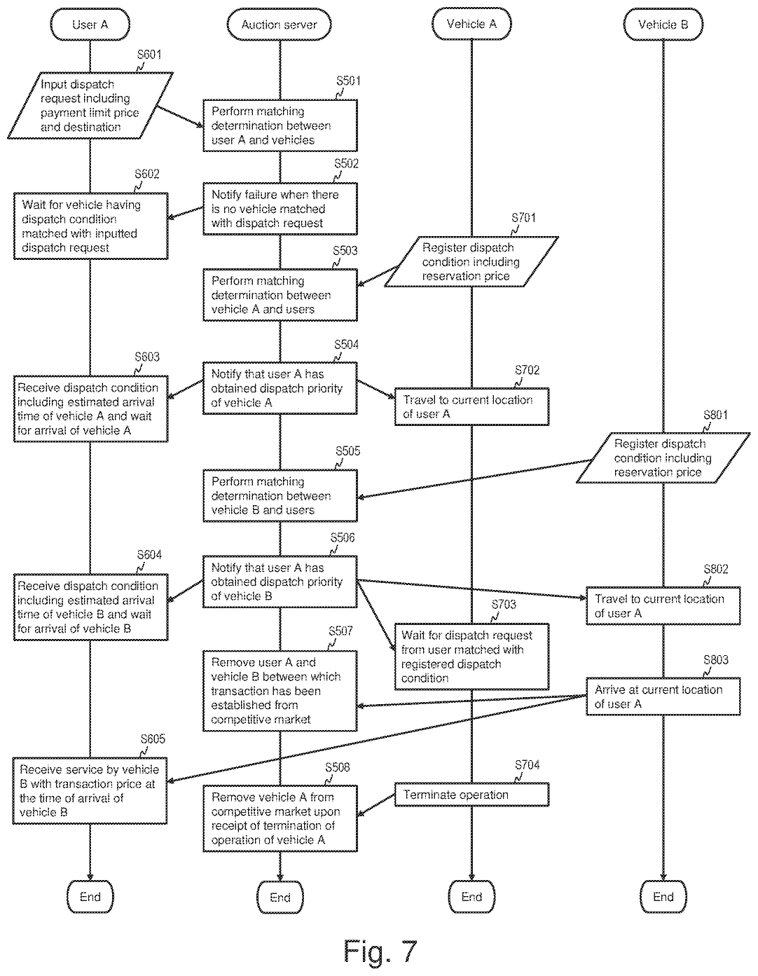

FIG. 7 is a flow chart showing the relationship between the user 30A, the vehicles 50A and 50B, and the auction server 10 in the case shown in FIG. 6. In the flowchart, the user 30A is denoted as user A, and the vehicles 50A and 50B are denoted as Vehicle A and Vehicle B.

If the user 30A participates in the competitive market, the user 30A inputs a dispatch request including a payment limit price and destination to the auction server 10 by using the user terminal (Step S601). The auction server 10 in which the dispatch request is input performs a matching determination between the user 30A and vehicles (Step S501). If no vehicle meets the dispatch condition as a result of the matching determination, the auction server 10 notifies the user 30A of the failure of the matching (Step S502). The vehicle 50A that has received the notification of the failure waits for matching with the vehicle having the dispatch condition that meets the input dispatch request (Step S602).

If the vehicle 50A participates in the competitive market, the vehicle 50A registers a dispatch condition including a reservation price to the auction server 10 by using the dispatcher terminal (Step S701). The auction server 10 in which the dispatch condition is registered performs a matching determination between users and the vehicle 50A (Step S503). If a match is established between the user 30A and the vehicle 50A, the auction server 10 notifies both the user 30A and the vehicle 50A that the user 30A has obtained the dispatch priority of the vehicle 50A (Step S504). The user 30A receives the dispatch condition including an estimated arrival time of the vehicle 50A and waits for the arrival of the vehicle 50A (Step S603). The vehicle 50A travels to the current location of the user 30A upon receipt of a notification from the auction server 10 (Step S702).

If the vehicle 50B participates in the competitive market, the vehicle 50B registers a dispatch condition including a reservation price to the auction server 10 by using the dispatcher terminal (Step S801). The auction server 10 in which the dispatch condition is registered performs a matching determination between users and the vehicle 50B (Step S505). Until the vehicle 50A arrives at the current location of the user 30A, the user 30A is also subject to the matching determination with the vehicle 50B in the competitive market. When a match is established between the user 30A and the vehicle 50B, the auction server 10 notifies the user 30A that the dispatch priority has changed from the dispatch priority of the vehicle 50A to the dispatch priority of the vehicle 50B. Further, the auction server 10 notifies the vehicle 50B that the user 30A has obtained the dispatch priority of the vehicle 50B, and notifies the vehicle 50A of cancellation of the dispatch (Step S506). The user 30A receives the dispatch condition including an estimated arrival time of the vehicle 50B and waits for the arrival of the vehicle 50B (Step S604). The vehicle 50B travels to the current location of the user 30A upon receipt of a notification from the auction server 10 (Step S802). On the other hand, the vehicle 50A of which the dispatch was canceled will wait for the dispatch request from the user that meets the registered dispatch condition (Step S703).

When the vehicle 50B arrives at the current location of the user 30A, the vehicle 50B notifies the auction server 10 and the user 30A of arrival at the dispatch destination (Step S803). The auction server 10 removes the user 30A and the vehicle 50B between which the transaction was established from the competitive market (Step S507). This prevent other vehicles from reverse bidding to the user 30A. The user 30A receives the service by the vehicle 50B at the transaction price established at the time of arrival of the vehicle 50B (Step S605). After the vehicle 50B arrives at the destination, the user 30A pays the fee and evaluates the vehicle dispatch service by the vehicle 50B.

The vehicle 50A may terminate the operation if the matching with users is not established (Step S704). The auction server 10 then receives a notification of the termination of the operation from the vehicle 50A and removes the vehicle 50A from the competitive market (Step S508).

### 4. Other Embodiments

The dispatcher terminal 40 may be mounted on individual vehicles 50. The dispatch condition of each vehicle 50 is individually transmitted from the dispatcher terminal 40 mounted on each vehicle 50. Of the dispatch condition transmitted from each dispatcher terminal 40, the current location of the vehicle 50 can be obtained by GPS, the reservation price, the dispatchable area, the number of passengers allowed to board, etc. can be determined in advance. In addition, the reservation price may be automatically determined according to the time zone and operating conditions.

The vehicle 50 may be a vehicle that is driven by a driver, such as a taxi. In that case, information may be sent from the dispatcher terminal 40 to the vehicle 50 to display a temporary price or a user's boarding location or a path thereto on the display panel in the vehicle 50. As for the path, it is desirable to select and display the route that does not change abruptly as the user changes. Also, similarly to the case where the vehicle 50 is an autonomous driving vehicle, the dispatcher terminal 40 may be disposed in the management center of the vehicle 50, and may be disposed in individual vehicles 50. If the dispatcher terminal 40 is disposed in individual vehicles 50, the driver may be able to input the dispatch condition arbitrarily.

The vehicle dispatch service providing system according to the present disclosure may be constituted by a peer-to-peer type system. In other words, the dispatch request acquiring unit, the dispatch condition acquiring unit, the bidding unit, the reverse bidding unit, the dispatching unit, and the payment price determining unit may be configured to be realized by the cooperation of the one or more user terminals and the one or more dispatcher terminals, which are connected via the communication network.

What is claimed is:

1. A vehicle dispatch service providing system for matching a dispatch condition of a vehicle with a dispatch request received from a user desiring vehicle dispatch service and dispatching the vehicle to the user who has presented the dispatch request that matches the dispatch condition, the vehicle dispatch service providing system comprising:
a dispatch request acquiring unit that acquires the dispatch request including at least a boarding location, a destination, and a payment limit price from the user who requests for vehicle dispatch;
a bidding unit that sets, as a provisional highest dispatch request, the dispatch request having the highest satisfaction in a predetermined bid evaluation item among one or more dispatch requests that match the dispatch condition, and updates the provisional highest dispatch request when a new dispatch request that matches the dispatch condition and has a higher satisfaction in the bid evaluation item than the provisional highest dispatch request is acquired by a time the vehicle dispatch is completed; and
a dispatching unit that directing the vehicle to the boarding location designated by the provisional highest dispatch request, and, when the provisional highest dispatch request is updated while the vehicle is traveling to the boarding location designated by the provisional highest dispatch request, changes a dispatch destination to the boarding location designated by the provisional highest dispatch request that is updated.

2. The vehicle dispatch service providing system according to claim 1, wherein the bid evaluation item is an upper limit of a price per travel distance including traveling to the boarding location.

3. The vehicle dispatch service providing system according to claim 1, further comprising a payment price determining unit that determines a payment price by second price auction method.

4. The vehicle dispatch service providing system according to claim 3, wherein the payment price determining unit determines, as the payment price, a price obtained by multiplying a payment limit price of a competitor who has presented the dispatch request having a next highest satisfaction in the bid evaluation item after a successful bidder by a ratio of a total travel distance necessary for performing the vehicle dispatch service to the successful bidder to a total travel distance necessary for performing the vehicle dispatch service to the competitor.

5. The vehicle dispatch service providing system according to claim 1, wherein the dispatch condition includes at least a reservation price.

6. The vehicle dispatch service providing system according to claim 5, wherein the reservation price is a minimum price per travel distance including traveling to the boarding location.

7. The vehicle dispatch service providing system according to claim 1, further comprising:
a dispatch condition acquiring unit that acquires the dispatch condition from a vehicle dispatcher that provides the vehicle to the vehicle dispatch service; and
a reverse bidding unit that sets, as a provisional highest dispatch condition, the dispatch condition having the highest satisfaction in a predetermined reverse bid evaluation item among one or more dispatch conditions that match the provisional highest dispatch request, and updates the provisional highest dispatch condition when a new dispatch condition that matches the provisional highest dispatch request and has a higher satisfaction in the reverse bid evaluation item than the provisional highest dispatch condition is acquired by a time the vehicle dispatch is completed,
wherein the dispatching unit dispatches the vehicle that presents the provisional highest dispatch condition for the provisional highest dispatch request, and, when the provisional highest dispatch condition is updated, changes the vehicle to be dispatched for the provisional highest dispatch request to the vehicle that presents the provisional highest dispatch condition that is updated.

8. The vehicle dispatch service providing system according to claim 7, wherein the reverse bid evaluation item is a time required for the vehicle to arrive at the dispatch destination.

9. The vehicle dispatching service providing system according to claim 1, wherein the vehicle is an autonomous driving vehicle and operates in accordance with an instruction from the dispatching unit.

10. A server for vehicle dispatch service connected to one or more user terminals via a communication network, comprising:
at least one processor; and
at least one memory including at least one program coupled with the at least one processor,
wherein the at least one program causes the at least one processor to execute:
a dispatch request receiving process of receiving a dispatch request including at least a boarding location, a destination, and a payment limit price from the one or more user terminals;
a bidding process of setting, as a provisional highest dispatch request, the dispatch request having the highest satisfaction in a predetermined bid evaluation item among one or more dispatch requests that match a dispatch condition of a vehicle;
a dispatching process of directing the vehicle to the boarding location designated by the provisional highest dispatch request;
a re-bidding process of updating the provisional highest dispatch request when a new dispatch request that matches the dispatch condition and has a higher satisfaction in the bid evaluation item than the provisional highest dispatch request is received by a time the vehicle dispatch is completed; and
a dispatch destination changing process of changing a dispatch destination, when the provisional highest dispatch request is updated, to the boarding location designated by the provisional highest dispatch request that is updated.

11. The server for vehicle dispatch service according to claim 10, wherein the at least one program causes the at least one processor to further execute a payment price determining process of determining a payment price by second price auction method.

12. The server for vehicle dispatch service according to claim 11, wherein in the payment price determining process, a price obtained by multiplying a payment limit price included in the dispatch request having a second highest satisfaction in the bid evaluation item by a ratio of a total travel distance calculated from the dispatch request having the highest satisfaction to a total travel distance calculated from the dispatch request having the second highest satisfaction is determined as the payment price.

13. The server for vehicle dispatch service according to claim 10, wherein the dispatch condition includes at least a reservation price.

14. The server for vehicle dispatch service according to claim 10, wherein the server is connected to one or more dispatcher terminals via the communication network, and the at least one program causes the at least one processor to further execute:
a dispatch condition receiving process of receiving the dispatch condition from the one or more dispatcher terminals;
a reverse bidding process of setting, as a provisional highest dispatch condition, the dispatch condition having the highest satisfaction in a predetermined reverse bid evaluation item among one or more dispatch conditions that match the provisional highest dispatch request;
a dispatch vehicle selecting process of dispatching the vehicle that presents the provisional highest dispatch condition for the provisional highest dispatch request;
a re-reverse bidding process of updating the provisional highest dispatch condition when a new dispatch condition that matches the provisional highest dispatch request and has a higher satisfaction in the reverse bid evaluation item than the provisional highest dispatch condition is received by a time the vehicle dispatch is completed; and
a dispatch vehicle changing process of changing the vehicle to be dispatched for the provisional highest dispatch request, when the provisional highest dispatch condition is updated, to the vehicle that presents the provisional highest dispatch condition that is updated.

15. A vehicle dispatch service providing method for matching a dispatch condition of a vehicle with a dispatch request received from a user desiring vehicle dispatch service and dispatching the vehicle to the user who has presented the dispatch request that matches the dispatch condition, the vehicle dispatch service providing method comprising:
receiving a dispatch request including at least a boarding location, a destination, and a payment limit price from one or more users;
setting, as a provisional highest dispatch request, the dispatch request having the highest satisfaction in a predetermined bid evaluation item among one or more dispatch requests that match the dispatch condition, and granting priority of dispatch of the vehicle to the user who has presented the provisional highest dispatch request;
directing the vehicle to the boarding location designated by user who has the priority;
updating the provisional highest dispatch request when a new dispatch request that matches the dispatch condition and has a higher satisfaction in the bid evaluation item than the provisional highest dispatch request is received by a time the vehicle dispatch is completed, and transferring the priority to the user who has presented the provisional highest dispatch request that is updated; and
changing a dispatch destination, when the priority is transferred to another user, to the boarding location designated by another user who has acquired the priority.

16. The vehicle dispatch service providing method according to claim 15, further comprising determining a payment price by second price auction method.

17. The vehicle dispatch service providing method according to claim 16, wherein the payment price is calculated by multiplying a payment limit price of a competitor who has presented the dispatch request having a next highest satisfaction in the bid evaluation item after a successful bidder by a ratio of a total travel distance necessary for performing the vehicle dispatch service to the successful bidder to a total travel distance necessary for performing the vehicle dispatch service to the competitor.

18. The vehicle dispatch service providing method according to claim 15, wherein the dispatch condition includes at least a reservation price.

19. The vehicle dispatch service providing method according to claim 15, further comprising:
receiving the dispatch condition from one or more vehicle dispatchers that provide the vehicle to the vehicle dispatch service;
setting, as a provisional highest dispatch condition, the dispatch condition having the highest satisfaction in a predetermined reverse bid evaluation item among one or more dispatch conditions that match the provisional highest dispatch request, and granting to the user who has presented the provisional highest dispatch request the priority of dispatch of the vehicle that presents the provisional highest dispatch condition; and
updating the provisional highest dispatch condition when a new dispatch condition that matches the provisional highest dispatch request and has a higher satisfaction in the reverse bid evaluation item than the provisional highest dispatch condition is received by a time the vehicle dispatch is completed, and changing the priority granted to the user who has presented the provisional highest dispatch request to the priority of dispatch of the vehicle that presents the provisional highest dispatch condition that is updated.
